(19) United States
(12) Patent Application Publication
(10) Pub. No.: US 2021/0187911 A1
(43) Pub. Date: Jun. 24, 2021

(54) LAMINATED FILTERING STRUCTURE

(71) Applicant: SAINT-GOBAIN GLASS FRANCE, COURBEVOIE (FR)

(72) Inventor: Keihann YAVARI, MARGNY-LES-COMPIEGNE (FR)

(21) Appl. No.: 17/057,330

(22) PCT Filed: May 29, 2019
(86) PCT No.: PCT/FR2019/051283

§ 371 Date: Nov. 20, 2020

(30) Foreign Application Priority Data
May 31, 2018 (FR) 1854717

(51) Int. Cl. B32B 17/10

(52) U.S. Cl. CPC B32B 17/10036; B32B 17/1044; B32B 17/10614; B32B 2307/412; B32B 2605/08; B32B 2313/04; B32B 2315/08; B32B 2419/00; B32B 2250/44

(57) ABSTRACT

A laminated structure, includes two glass sheets, one exterior and one interior, that are bound together by an interlayer including at least one layer of a plastic material, the exterior first sheet delineating an exterior surface of the structure and the second glass sheet delineating an interior surface of the structure, the structure further including, between the two glass sheets, a louver film that selectively filters towards the interior surface light rays incident on at least one segment of the exterior surface of the structure, the film having a louver angle α included between 15° and 75° with respect to the normal to the exterior surface of the structure.

The invention relates to a laminated structure, in particular a windshield, that possesses a capacity to selectively and directionally filter some of the light radiation, in particular solar radiation, that passes therethrough.

At the present time, motor-vehicle windshields are obtained from a laminated structure, i.e. from a composite structure in which two glass sheets are intimately bound together via an interlayer made of plastic material, and most often consisting of one or more films of polyvinyl butyral (PVB).

Furthermore, in recent vehicles, a tendency to maximize the glazed portions surrounding the passenger compartment of the vehicle, so as to allow its occupants with 360° panoramic vision, has been observed.

Furthermore, with such a view in mind, new windshields have been developed, the area of which is very much larger than conventional windshields, in particular because of an extension of the glazing to cover some of the roof of the vehicle. Thus, it is commonplace at the present time for the top portion of windshields to extend to above the head of the driver, or even therebeyond.

Although such a configuration effectively allows a maximum light level and maximum vision of the environment of the vehicle from the interior of thereof to be ensured, it however raises the problem how to prevent the driver from being subjected to glare, in particular under high insolation.

In particular, when the sun is at its zenith or close thereto and in front of the driver, the intense radiation arriving directly into his eyes may cause the driver intense discomfort. To mitigate this problem, provision is most often made for a sliding or foldable panel may be deployed to cover the upper portion of the windshield. However, when this panel is in occulting position, the “transparent” segment of the glazing becomes much smaller and the light level in the interior of the passenger department decreases, in particular for passengers sat on the rear passenger seats of the vehicle.

Furthermore, the use of windshields of large size of the type described above leads to increased reflection of light from the dashboard.

There is thus at the present time, for such glazed areas, a need for a solution that allows the glare to which drivers are subjected under bright sunshine to be limited while maintaining a high light level in the rest of the passenger compartment, in particular at the rear of the vehicle and in particular a good visibility of the in-front exterior to the passengers.

The object of the present invention is to propose such a solution.

More precisely, the present invention relates, firstly, to a laminated structure, comprising two glass sheets, one exterior and one interior, that are bound together by an interlayer consisting of at least one layer of a plastic material, said exterior first sheet delineating an exterior surface of said structure and said second glass sheet delineating an interior surface of said structure, said structure being characterized in that it furthermore comprises, between the two glass sheets, a louver film that selectively filters light rays incident on at least a part of the exterior surface of said structure, said film having a louver angle α comprised between 15° and 75° with respect to the normal to the exterior surface of said structure.

According to the invention, the louver film comprises and preferably consists of a succession of transmissive strips that transmit and absorbent strips that absorb the incident light. According to the invention, the strips alternate preferably parallel to the length of the film (which corresponds to the horizontal width of the laminated structure).

Preferably, the strips are continuous from one edge to the other of the film (and preferably of the laminated structure). Also preferably, they extend from the exterior surface to the interior surface of said film.

The film according to the invention advantageously allows light rays incident on at least one segment of the exterior surface of said structure to be selectively filtered toward the interior surface.

According to preferred embodiments of the present invention, which may where appropriate be combined together:
The film has a louver angle α comprised between 25° and 65° and more preferably comprised between 30° and 60° with respect to the normal to the exterior surface of said structure.
The louver film is encapsulated into the plastic material forming the interlayer.
The louver film forms all or some of the interlayer.
The louver film has a thickness comprised between 0.1 mm and 0.5 mm.
The material forming the absorbent strips incorporates carbon-black particles.
The pitch between two successive transmissive regions is comprised between 3 and 200 microns, more preferably is comprised between 5 and 100 microns, or even between 10 and 80 microns and very preferably is comprised between 20 and 60 microns.
Said transmissive and absorbent strips are strips placed substantially parallel to one another and oriented with a louver angle α comprised between 15° between 75°, preferably comprised between 25 and 65°, or even comprised between 30° and 60°, with respect to the normal to the exterior surface of said structure.
The thickness of the absorbent strips is comprised between 1 and 70 microns, preferably between 3 and 40 microns, and more preferably 5 and 20 microns.
The thickness of the transmissive strips is comprised between 2 and 130 microns, preferably between 7 and 80 microns, and more preferably 10 and 30 microns.
The thickness of the transmissive strips is larger than the thickness of the absorbent strips, preferably by a factor higher than or equal to 1.5.
The pitch between two transmissive strips is comprised between 0.5 times and 5 times the thickness of the film.

The invention most particularly relates to a windshield consisting of or comprising a laminated structure such as described above. According to one such embodiment, the louver film may be present solely in the top third of said structure, or even solely in the top quarter of said structure.

According to another embodiment, the invention relates to a roof window, in particular for a building or a dwelling, consisting of or comprising a laminated structure such as described above.

According to one alternative embodiment, the invention relates to a sunroof and/or panoramic sunroof, comprising a laminated structure such as described above. In one such embodiment, the louver angle may be smaller than 15°, for example smaller than 10° or even smaller than 5°, or even substantially zero.

One nonlimiting embodiment of the present invention is described below with reference to the appended figures, it being understood that the various aspects described with regard to said embodiment must not be considered to limit the present invention.

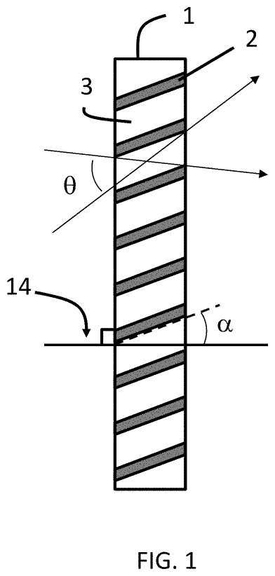

FIG. 1 illustrates a schematic view of a louver film that selectively filters incident light rays, i.e. incident sunlight, such as it may be used in a structure according to the present invention.

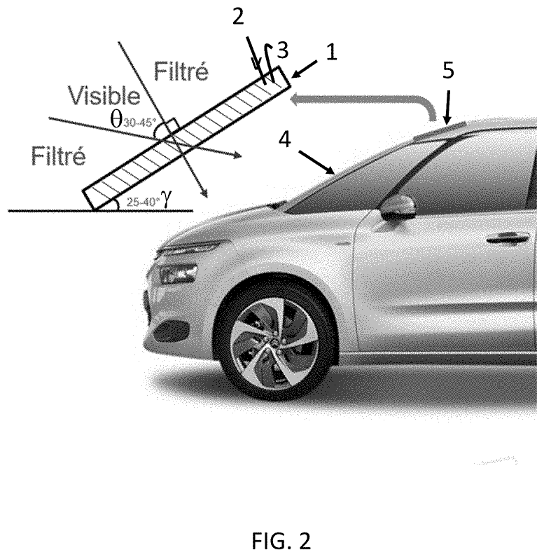

FIG. 2 allows the use of a laminated structure according to the invention, here in the form of a laminated windshield that incorporates a louver film such as described in FIG. 1, to be seen.

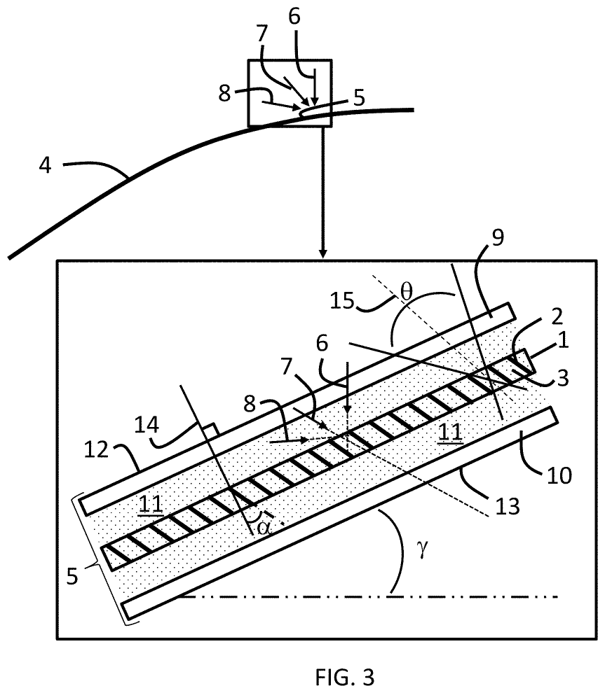

FIG. 3 shows in detail a cross section of a structure of the laminated windshield of FIG. 2 and in particular illustrates the operation and the advantages of such a structure.

FIG. 1 shows a structure typical of a louver film the technology of which and the materials used in which are well known, for example from publications U.S. Pat. Nos. 8,503,122, 8,213,082, 5,254,388 EP0563241, WO2007/118122, EP 1501696, or even U.S. Pat. No. 6,924,912. These structures are for example used as privacy filters on computer screens, so that only the person positioned substantially facing the screen can see the information displayed thereon.

In one example embodiment of such a film, absorbent regions or strips 2 that absorb the incident radiation (the radiation of the sun) alternate with transmissive regions or strips 3 that transmit the same radiation, i.e. let the incident light pass. These regions take the form of strips. In the context of the present invention, what is in particular meant by “strip” is a structure of substantially constant thickness over all its width and all its length.

Preferably, according to the invention, in the region of the laminated structure in which they are present, the strips according to the invention extend right through the entire thickness and more preferably the entire length of the louver film in which they are incorporated. For example, and without limiting the present invention, the transmissive regions or strips 3 may be made of a second plastic material that is identical or different to the preceding one, and furthermore comprise carbon black or any absorbent material that absorbs visible light partially or completely.

According to the present invention, the absorbent strips 2 and the transmissive strips 3 alternate, with a louver angle α comprised between 15 and 80°, and preferably comprised between 25 and 65°, with respect to the normal 14 to the exterior surface of the film (and therefore of the laminated structure incorporating it), for reasons that will be explained below with reference to FIGS. 2 and 3.

According to the invention, the thickness of the absorbent and transmissive strips is constant and their spacing is regular. The inclination combined with the spacing between the two regions furthermore allows the cut-off angle θ of the incident light to be adjusted, in a filtering and operating mode similar to that obtained with the slits of a Venetian blind.

FIG. 2 shows one possible and advantageous use of a laminated structure according to the invention, here in the form of a laminated windshield 4 that incorporates a louver film 1 configured to select, in the top portion 5 thereof, a portion of the radiation of the incident light. For example, the louver film is present solely in the top third of said structure, or even solely in the top quarter of said structure. By top third or top quarter what is meant is the part of the windshield, the area of which represents one third or one quarter of the total area of the windshield, starting from the top edge of the windshield such as positioned in the vehicle and in a longitudinal direction.

As indicated above with reference to the technical problem underlying the present invention, the windshield 4 is configured to select one portion of the radiation of the incident light, so as on the one hand to avoid too strong an illumination of the driver, while on the other hand preserving a high light level in the interior of the passenger compartment and in particular for passengers sat at the rear of the vehicle. In all the figures, the same numbers have been used to reference elements that are identical or of same nature.

As indicated in FIG. 2, the louver film 1 inserted into the top portion 5 of the windshield 4 allows solar light incident on the windshield to be selectively filtered. In this top portion, the glazing makes an obtuse angle γ to the ground, for example an angle comprised between 15 and 40°, or even less. For reasons of simplicity, the surface shown in FIGS. 2 and 3 is planar but it is of course possible or even frequent for this surface 5, just like the windshield 4 in its entirety, to be curved.

According to one advantage related to the implementation of the present invention, only light rays arriving at a defined angle of incidence pass through the windshield. It is thus possible to define, with a given configuration of the absorbent and transmissive regions, which in particular take the form of strips, a cut-off angle θ and to adjust the central axis 15 thereof, as indicated in FIGS. 2 and 3, so as to specifically select radiation travelling toward a position of the passenger compartment, and in particular toward the rear passengers, while preserving the driver from too strong an insolation.

The implementation of the present invention and its advantages are illustrated in more detail in FIG. 3, which shows in more detail an example of the top portion 5 of the laminated structure 4 according to the invention and its action on three light rays, having a substantially vertical incidence (symbolized by the arrow 6), a substantially horizontal incidence (symbolized by the arrow 8) and an oblique incidence (symbolized by the arrow 7), with respect to the ground.

The windshield illustrated in FIG. 3 has a laminated structure 4 that is conventional for such a structure: two glass sheets, one interior 10 and the other exterior 9, are bound together by an interlayer 11, which is generally made of polyvinyl butyral (PVB). In the top portion 5 of the windshield, and more particularly in the segment of the windshield directly above the driver of the vehicle, the louver film is placed such as described with reference to FIG. 1. The windshield has in this region an angle γ that may vary between 25 and 40° to the horizontal. The louver film 1 is configured in such a way that the substantially vertical ray 6 and the substantially horizontal ray 8 are completely or partially absorbed by an absorbent region 2 of the windshield, whereas the ray 7 reaching the windshield with an oblique incidence passes therethrough substantially without absorption toward the interior surface 13 of the windshield portion and the rear of the passenger compartment. Thus, a film that occults or partially occults the driver of the vehicle, in particular when the sun is directly above the windshield, while preserving a high light level in the passenger compartment of the vehicle is obtained.

For example, it will be possible to very easily adjust the cut-off angle by adjusting the respective thickness and the spacing between the absorbent regions and transmissive regions. According to the invention, the angle may be adjusted to values comprised between 20 and 50° in order to obtain a sufficiently wide range allowing a very strong illumination of the passenger compartment, whatever the position of the sun above the vehicle. In the top portion of the glazing where the louver film is position, the angle γ between the windshield and the horizontal is in general comprise between 15 and 40°.

The value of the louver angle α is in general adjusted so as to let a maximum of the light rays directed toward the rear of the passenger compartment pass and to stop, at least partially, or even completely or almost completely, solar radiation coming directly from the sun when the latter is close to its maximum height, i.e. directly above the vehicle, and directed toward the driver (i.e. substantially as the vertical ray 6).

According to the present invention, the windshield may of course have a curvature in the zone into which the louver film is incorporated. The principles described above of course remain the same as those described above.

According to another embodiment of the invention, which embodiment is not illustrated in the drawings, the louver film may form all or some of the interlayer present between the two constituent glass sheets of the laminated structure.

The invention has just been described with reference to one embodiment in which the laminated structure is a motor-vehicle windshield. It is of course also possible to use the laminated structure described in the claims that follow in other applications, and in particular in roof windows. Such roof windows are positioned on roofs at an angle with respect to the horizontal in order to substantially respect the plane of the roof. In such a case also, the use of a louver film has the same advantages as described above, these advantages not being repeated here for the sake of concision.

1. A laminated structure, comprising an exterior first glass sheet and an interior second glass sheet, that are bound together by an interlayer consisting of at least one layer of a plastic material, said exterior first glass sheet delineating an exterior surface of said structure and said interior second glass sheet delineating an interior surface of said structure, said structure comprising, between the exterior first glass sheet and the interior second glass sheet, a louver film, said louver film having a louver angle α comprised between 15° and 75° with respect to a normal to the exterior surface of said structure, the louver film comprising an alternation of transmissive strips that transmit incident light and of absorbent strips that absorb the incident light, said transmissive and absorbent strips being placed parallel to one another.

2. The laminated structure as claimed in claim 1, wherein said louver film has a louver angle α comprised between 25° and 65° with respect to the normal to the exterior surface of said structure.

3. The laminated structure as claimed in claim 1, wherein the louver film is encapsulated into the plastic material forming the interlayer.

4. The laminated structure as claimed in claim 1, wherein the louver film forms all or some of the interlayer.

5. The laminated structure as claimed in claim 1, wherein the louver film has a thickness comprised between 0.1 mm and 0.5 mm.

6. The laminated structure as claimed in claim 1, wherein the louver film consists of an alternation of transmissive strips that transmit and absorbent strips that absorb the incident light from the exterior surface to the interior surface of said structure.

7. The laminated structure as claimed in claim 1, wherein a pitch between two successive transmissive regions is comprised between 3 and 200 microns.

8. The laminated structure as claimed in claim 1, wherein the material forming the absorbent strips contains carbon-black particles.

9. The laminated structure as claimed in claim 1, wherein said transmissive and absorbent strips are placed substantially parallel to one another and oriented with a louver angle α comprised between 15° between 75° with respect to the normal to the exterior surface of said structure.

10. The laminated structure as claimed in claim 1, wherein a thickness of the absorbent strips is comprised between 1 and 70 microns.

11. The laminated structure as claimed in claim 1, wherein a thickness of the absorbent strips is comprised between 2 and 130 microns.

12. The laminated structure as claimed in claim 1, wherein a thickness of the transmissive strips is larger than a thickness of the absorbent strips.

13. A windshield consisting of or comprising a laminated structure as claimed in claim 1.

14. The windshield as claimed in claim 13, wherein the louver film is present solely in the top third of said structure.

15. A roof window consisting of or comprising a laminated structure as claimed in claim 1.

16. A sunroof and/or panoramic sunroof, comprising a laminated structure as claimed in claim 1.

17. The laminated structure as claimed in claim 12, wherein the thickness of the transmissive strips is larger than the thickness of the absorbent strips by a factor higher than or equal to 1.5.

18. The windshield as claimed in claim 14, wherein the louver film is present solely in the top quarter of said structure.

19. The roof window as claimed in claim 15, wherein the roof window is a roof window of a building or a dwelling.
